(19) United States
(12) Patent Application Publication
(10) Pub. No.: US 2025/0007446 A1
(43) Pub. Date: Jan. 2, 2025

(54) SOLAR ARRAY WITH CARGO-CARRIER FOR A VEHICLE

(71) Applicant: Joseph W. MIGNONE, Varna, IL (US)

(72) Inventor: Joseph W. MIGNONE, Varna, IL (US)

(21) Appl. No.: 18/343,543

(22) Filed: Jun. 28, 2023

(51) Int. Cl. H02S 20/30; H02S 30/10; H02S 40/38

(52) U.S. Cl. CPC H02S 20/30; H02S 30/10; H02S 40/38; H02S 40/32

(57) ABSTRACT

A solar power system for a vehicle includes a solar array with at least one solar panel, where the solar array is configured to generate at least 400 watts of electrical power, a roof-mountable cargo-support structure with at least two generally parallel longitudinal rails attached to the solar array and constructed to support a cargo above the solar array and separated from the solar array by a predetermined distance, where at least one cross-member is permanently attached or removably attached to the at least two generally parallel longitudinal rails in a manner permitting support of a load above and separated from the solar array.

### TECHNICAL FIELD

Embodiments disclosed herein generally relate to a vehicle-roof-mountable solar array. More particularly the embodiments disclosed here relate to a combination cargo rack and solar power array for use on/with a vehicle.

### BACKGROUND

The price and availability of solar panels has improved markedly in recent years, as has the prevalence of rechargeable/cordless electric tools and other electronic devices. Also, there is an increased public consciousness to utilize energy resources that are alternative to and/or complementary to fossil-fuel-generated electricity. It may be desirable to provide a source of electrical power for use with portable tools and devices associated with a motor vehicle, as well as for the vehicle itself. Although roof-mounted solar panels on fuel-powered, electric, and hybrid vehicles have been known for many years, there is not a readily-available system that allows a user to have the benefit of both roof-mounted solar panels and cargo-carrying capability. The presently disclosed embodiments are directed to meeting these needs with a system that will be useful for work and/or recreational uses, including to meet a user's desire for electrical energy, cargo-carrying, or both (independent of each other).

### BRIEF SUMMARY

A solar power system for a vehicle includes a solar array with at least one solar panel, where the solar array is configured to generate at least 400 watts of electrical power, a roof-mountable cargo-support structure with at least two generally parallel longitudinal rails attached to the solar array and constructed to support a cargo above the solar array and separated from the solar array by a predetermined distance, where at least one cross-member is permanently attached or removably attached to the at least two generally parallel longitudinal rails in a manner permitting support of a load above and separated from the solar array.

### BRIEF DESCRIPTION OF THE DRAWINGS

FIG. 1 shows an overhead/elevated view of a cargo-carrying and solar power system, mounted on a vehicle, with an example cargo shown;

FIG. 1A illustrates the same as FIG. 1, but from about or eye level, as viewed from a rear/left perspective;

FIG. 2 shows a diagrammatic exploded view of a base frame with reference to installation components and relative positions;

FIG. 2A shows an elevated/overhead right-side view of the system, partially-assembled with only the base frame;

FIG. 2B shows an elevated left-rear view of the system, partially-assembled with only a base frame and solar panels;

FIG. 3 shows the system from an elevated perspective (above eye level) at a right-front corner, with an example cargo;

FIG. 4 shows the system from above eye level at a left-front corner;

FIG. 4A shows a zoomed-in partial view of the system from above eye level along a right-side; and

FIG. 5 is a diagrammatic view of example components of the cargo-carrying and solar power system.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not limited to those illustrated in the drawings. It should be understood that the drawings are not necessarily to scale, and in certain instances details may have been omitted that are not necessary for an understanding of embodiments disclosed herein, such as—for example—conventional fabrication and assembly.

A combined system of solar power and cargo-transport is disclosed, configured for being mounted onto a vehicle or vehicle accessory, where the solar power portion and cargo-transport system are independently useful.

The invention is defined by the claims, may be embodied in many different forms, and should not be construed as limited to the embodiments set forth herein; rather, these embodiments are provided so that this disclosure will be thorough and complete, and will fully convey enabling disclosure to those skilled in the art. As used in this specification and the claims, the singular forms “a,” “an,” and “the” include plural referents unless the context clearly dictates otherwise. Reference herein to any industry standards (e.g., ASTM, ANSI, IEEE standards) is defined as complying with the currently published standards as of the original filing date of this disclosure concerning the units, measurements, and testing criteria communicated by those standards unless expressly otherwise defined herein.

The terms “about,” “substantially,” “generally,” and other terms of degree, when used with reference to any volume, dimension, proportion, or other quantitative or qualitative value, are intended to communicate a definite and identifiable value within the standard parameters that would be understood by one of skill in the art (equivalent to a solar appliance or automotive accessory engineer with experience in this field), and should be interpreted to include at least any legal equivalents, minor but functionally-insignificant variants, standard manufacturing tolerances, and including at least mathematically significant figures (although not required to be as broad as the largest range thereof), and up to 5% variance unless otherwise specified. The phrase “eye level” refers to a horizontal sightline of a person who is ≤2 m in height, used in reference to a roofline height of a typical full-size pick-up truck, van, box truck, or other vehicle. “Generally parallel” includes completely parallel with variation of up to 15 degrees, but preferably less than 10 degrees. OTHER DEFINITIONS (IF ANY)

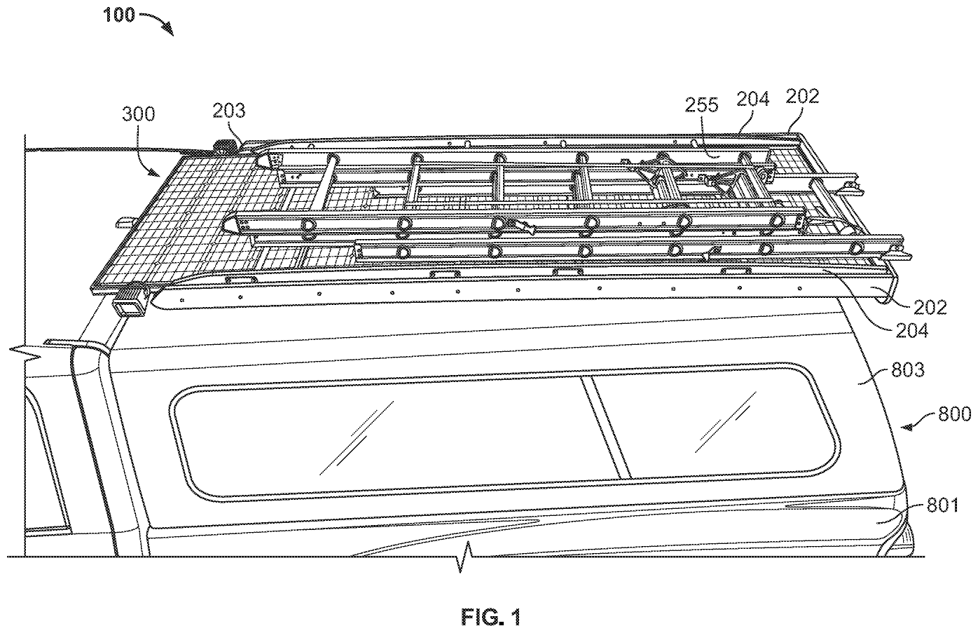

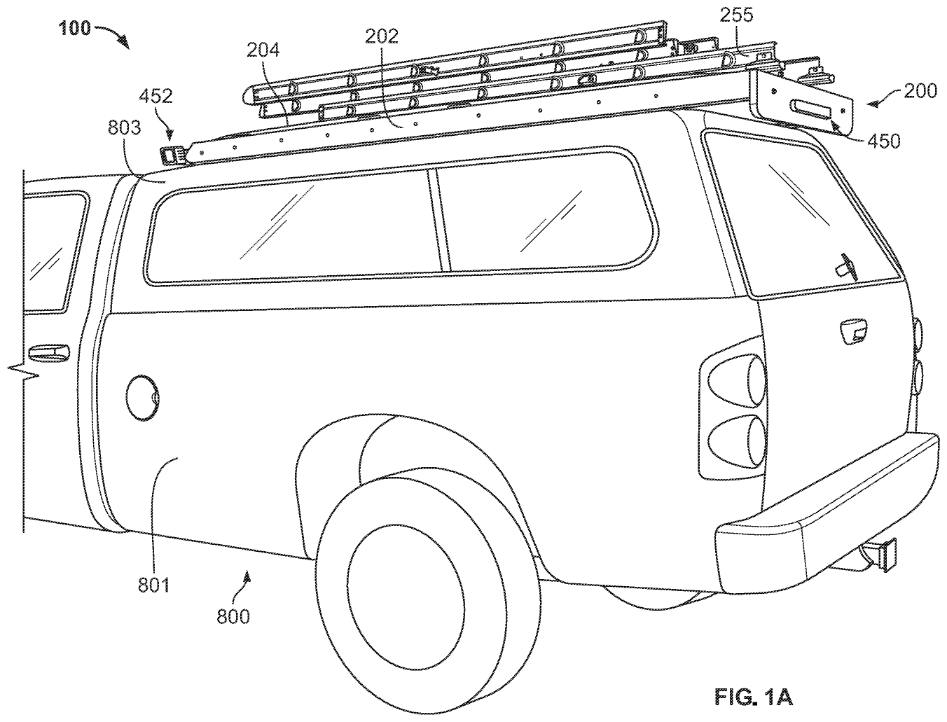

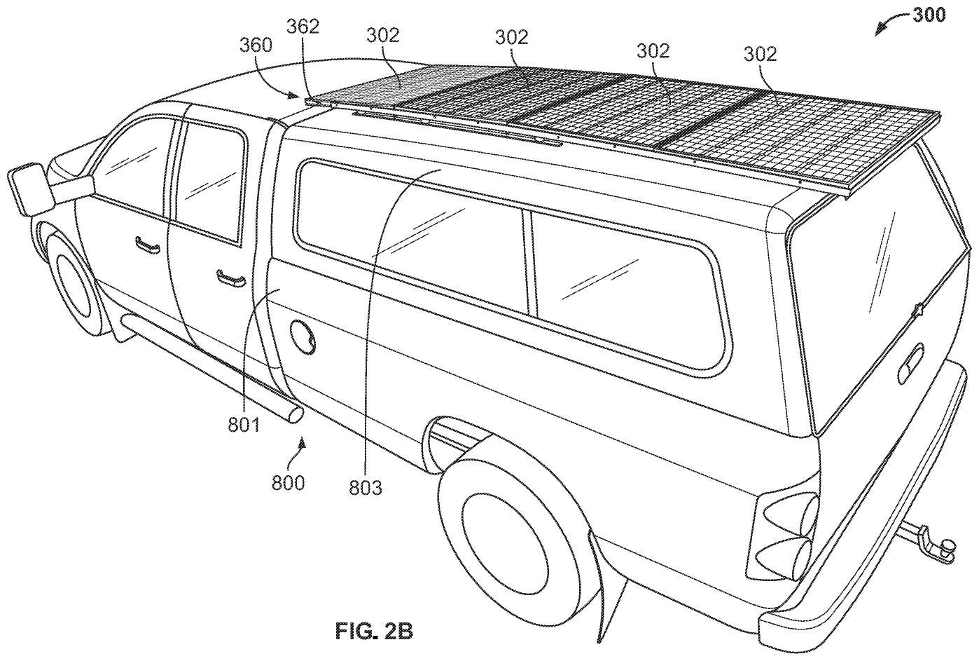

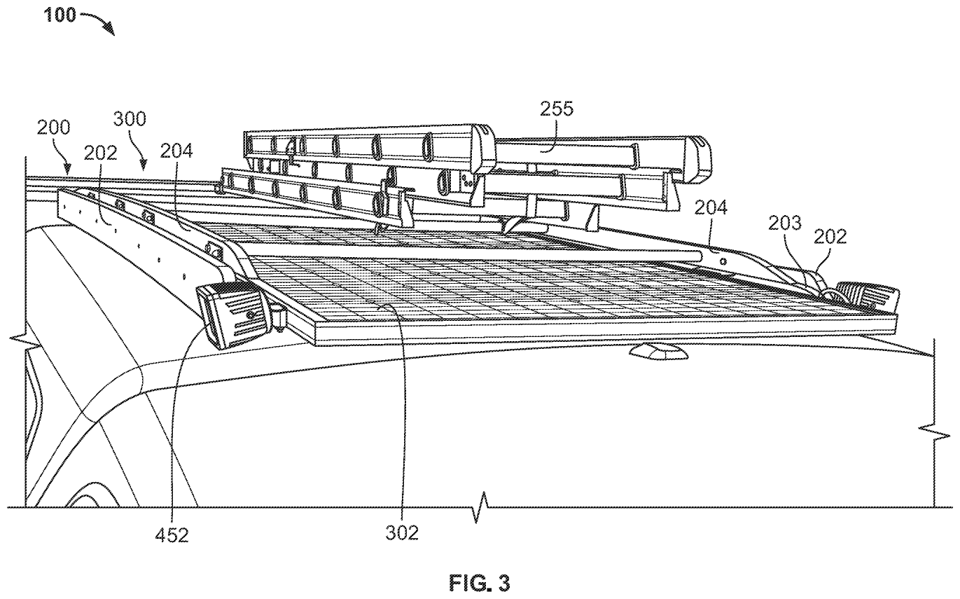

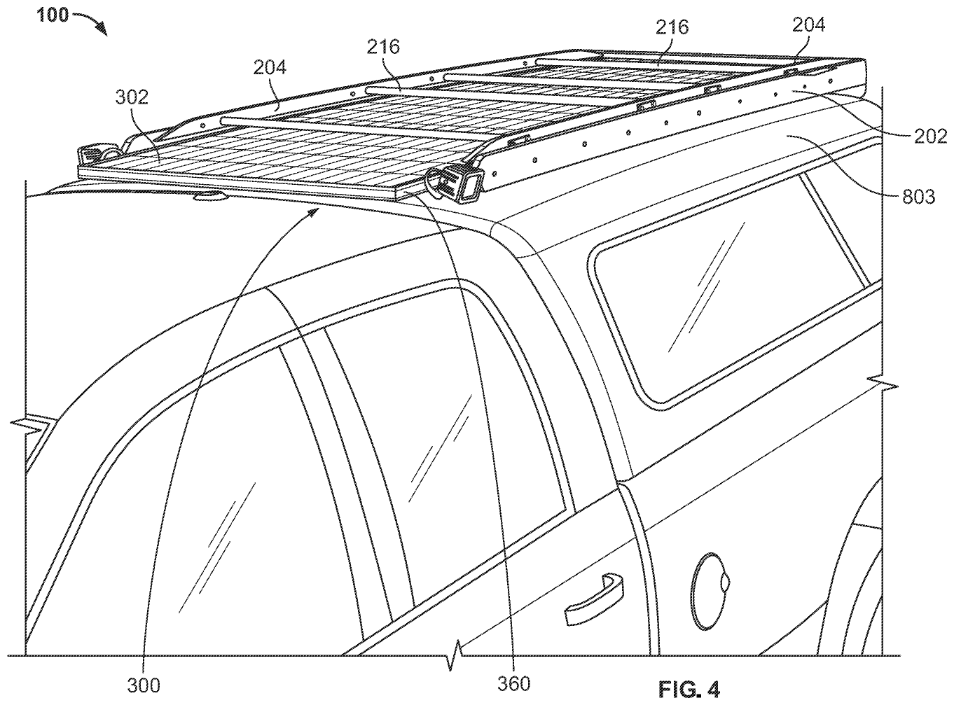

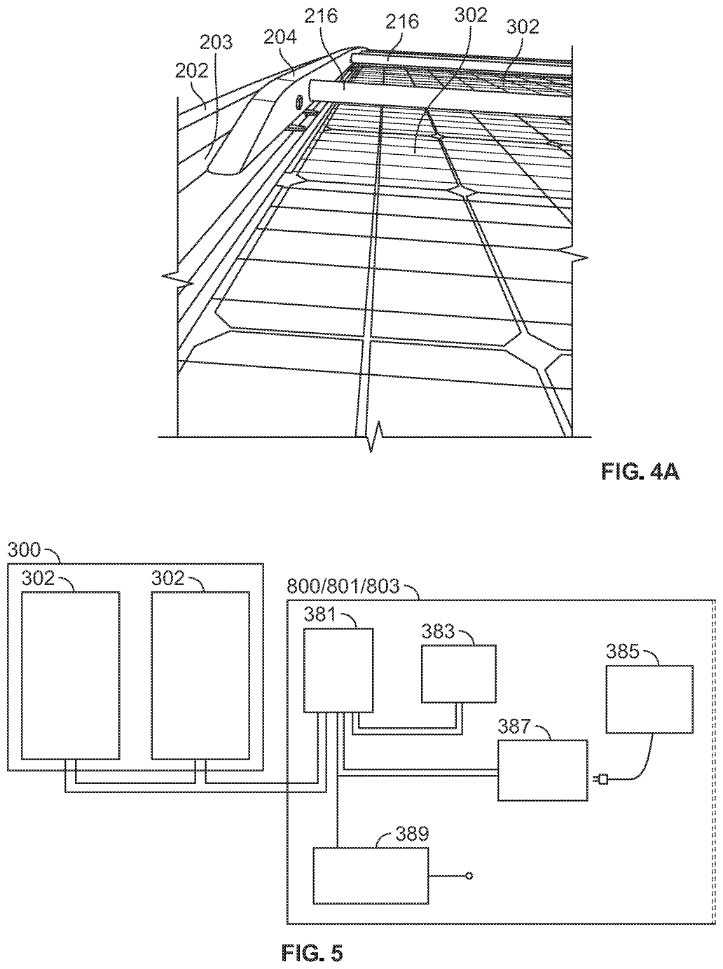

One embodiment of a cargo-carrying and solar power system 100 for a vehicle is described with reference to FIGS. 1-5. FIG. 1 shows an overhead/elevated view of the system 100 mounted to the roof of a vehicle/vehicle-accessory 800, where the vehicle is illustrated by way of non-limiting example as a full-sized pickup truck 801 with a mounted camper shell 803. FIGS. 1, 1A, and 3 also show a non-limiting example cargo load 255 (in the form of an extension ladder) removably disposed/attached upon the system, as further set forth below, while FIGS. 4-4A show the system without cargo placed thereon. This includes that the elements described herein may be contoured, shaped, or otherwise configured to fit with a vehicle and/or vehicle accessory in a manner for effectively and safely carrying a cargo load (e.g., balanced, leveled). This includes that the system 100 may be arched, bowed, and/or otherwise shaped to fit vehicle contours, which providing for carrying cargo at a desired orientation (e.g., level).

It should be appreciated that the system may be used on other vehicles with or without accessories including (by way of non-limiting example) at least vans, sport-utility vehicles, cars, camper/RVs, cargo/box trucks, bed-mountable camper units, trailer units (e.g., cargo trailers, camper trailers), and any other vehicle. The system 100 includes a cargo-support structure 200 and a solar array 300. The system 100 may include one or more accessory devices that may be powered by the solar array 300, the vehicle 801, or both. For example, a supplemental brake light 450, one, two, or more spot lights/work-lights 452, and/or other powered accessories may be included on the system 100. The system may also be configured to support any other DC load and/or AC load, including, by way of further non-limiting example, interfacing with a vehicle electrical system (e.g., to charge vehicle battery(ies), to provide alternative and/or supplemental power).

The solar array 300 includes at least one solar panel 302. Preferably, the solar array includes sufficient solar cells in solar panels 302 to generate at least 400 watts of electrical power. In one non-limiting example, the solar array may include four HQST™ 100 W solar panels dimensioned about 36 inches wide by 26 inches long by 1 inch thick, mounted using Renogy™ MTS-ZB brackets. A variety of commercially available solar panel products will be suitable for vehicle mounting including properties of durability, weight, resistance to weather/elements, and a balance of flexibility and rigidity to accommodate vehicle-mounted conditions including at least wind, snow, and dust. The particular dimensions and orientation of the panels 302 can be selected with reference to the type of vehicle and/or vehicle-mountable accessory to which the system 100 will be attached. Accordingly, the example embodiments shown and described here do not limit the number and/or orientation of solar panels used in an array, nor the mounting/framing used for accommodating them. Likewise, those of skill in the art will understand that different wiring configurations may be used within current safety standards.

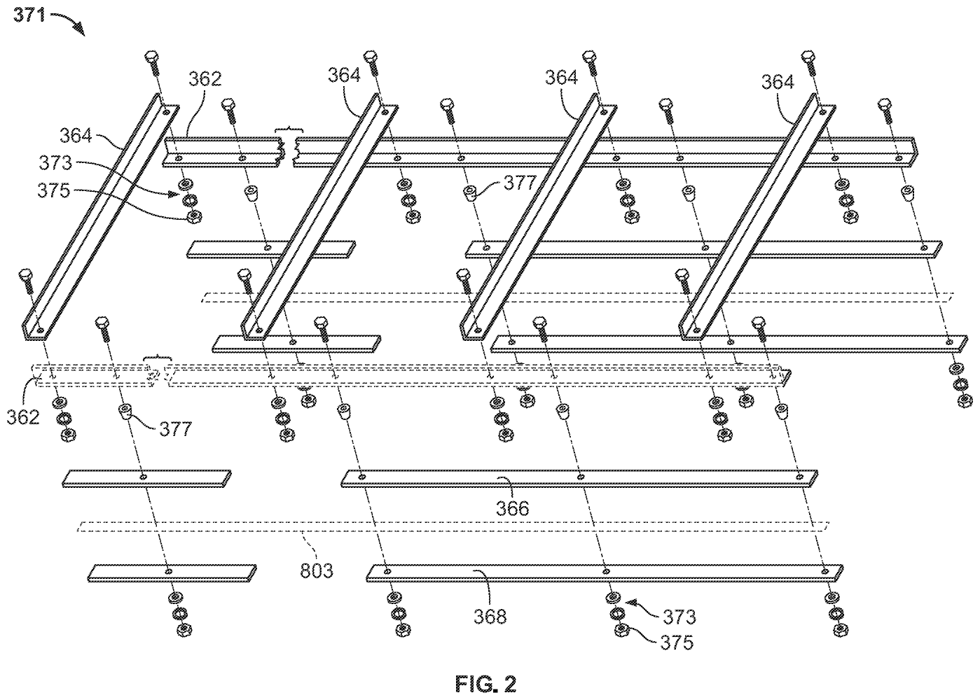

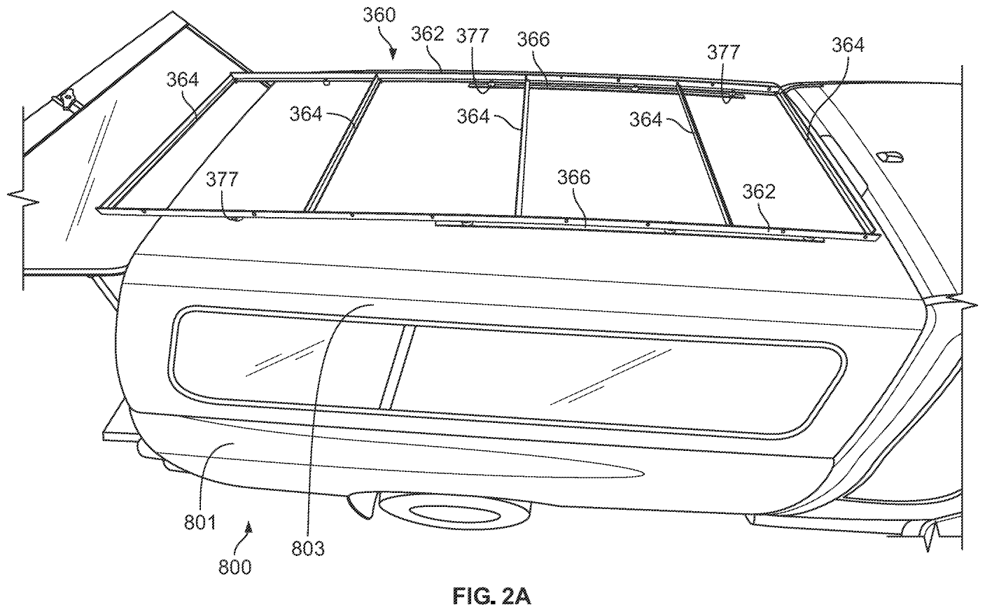

FIGS. 2 and 2A show partial/representative views (not-to-scale), respectively, of an exploded support frame 360 with vertical attachment components and the support frame 360 with horizontal attachment components, while FIG. 2B shows the frame 360 assembled and mounted on top of a truck camper shell by way of an example embodiment (without cargo-support structure installed). The illustrated embodiment of the support frame 360 includes two longitudinal aluminum angle-bars 362 and transverse aluminum angle-bars 364, as well as a pair of longitudinal aluminum external flat bars 366 and a pair of longitudinal aluminum internal flat bars 368. Aluminum is used for its advantageous features of lighter weight, resistance to corrosion, and general durability, but other embodiments may use other metals, polymers, composites, or combinations thereof as well as other materials that will provide appropriate structural integrity. FIG. 2 is diagrammatic, both in its rendering style, and with regard to the fact that it does not exhaustively show components or proportions of the frame 360. And, the present application is not directed to the cosmetic appearance or particular dimensions that each may be changed for particular uses, but remaining within the scope of the present disclosure.

The bars 362, 364, 366, 368 are shown as being secured together with bolts 371, washers and lock-washers 373, and nuts 375 (which may be lock-nuts) directed through pre-drilled holes. In some embodiments, self-tapping bolts/screws may be used, and it will be appreciated that other connectors can be used to secure these components. Specifically, the components described here may be attached and secured using any conventional structures and methods that will provide for secure, safe connection of the components of the system 100 (with each other, and when mounted to a vehicle and/or vehicle accessory). Bushings 377 are shown as optionally being disposed between the longitudinal angle-bars 362 and the external flat bars 366 (and/or the mounting substrate 803). The illustrated embodiment includes a four-cornered riser support system with materials configured to control sway, vibration, and other less-desirable movement of the system relative to a vehicle and any cargo.

When installed, the external flat bars 366 are disposed on the upper/external surface of the mounting substrate 803 (vehicle roof, vehicle accessory roof, or other mounting platform/element). And, the internal flat bars 368 are disposed on the lower/internal surface of that same substrate 803, aligned longitudinally with the external bars 366 and the longitudinal angle-bars 362. In some embodiments, insulated tape may be installed between one or both flat bars 366, 368 and the substrate 803. Also, it is preferred to seal around the bolts or other fasteners to maintain water-tightness (e.g., using silicone or other sealant material and/or seals such as gaskets, not shown). The term “flat bar” is used here with reference to the illustrated embodiment, which has bars that are laterally-flat, but it is not limited to that embodiment, and bars or other structures (e.g., tubes, curved bars, I-beams, and/or other geometries) may be used to provide the structural support shown and described, within the scope of the claimed invention. It should also be appreciated that these structures will provide weight-distribution, vibration-damping, and resistance to undesirable flex and/or sway of the system.

The solar panel(s) 302 are mounted to the frame 360 using conventional mounting attachments in keeping with the support boundaries and manufacturer recommendations for the selected solar pane(s). The conventional mounting attachments may include, by way of non-limiting example, one or more of bolts, screws, rivets, clips, clamps, adhesive(s), and/or weld(s). The solar array 300 and the cargo-support structure 200 may be configured as being independently and/or mutually attachable to a vehicle roof structure (which includes any vehicle accessory as described elsewhere). When one or both are attached to the roof it/they preferably are securely anchored enough so as not to move relative to the mounting substrate.

FIGS. 1, 1A, 3, 4, and 4A show the cargo-support structure 200, as mounted to the support frame 360 of the solar array 300. The cargo-support structure 200 includes a generally parallel longitudinal outer pair of first rails 202 and at generally parallel longitudinal inner pair of second rails 204. That is, all of the outer first and inner second rails 202, 204 are generally longitudinally parallel with each other. In the illustrated embodiment, the right-side inner second rail 204 is bolt-attached to the right-side outer first rail 202 and also bracket-attached to the solar array support frame 360, which is also true for the left side rails 202, 204. Each of the outer rails 202 is separately attached to the solar array support frame 360. An intermediate spacer/riser member 203 may be provided (e.g., for support and positioning) lengthwise between the outer/inner rails 202/204 and/or below a portion of the inner rails 204, as shown in FIGS. 1, 3, and 4A.

In order to provide for transporting cargo that would not span across the rails 202, 204, at least one cross-member 216 is disposed (that is permanently attached or removably attached) transverse to and across/between the longitudinal rails 202, 204. This preferably includes a plurality of cross-members 216. In the drawing figures, the cross-members 216 are attached directly to the inner rails 204, but it should be appreciated that-alternatively or in addition-they may be attached directly to the outer rails 202. The attachment of the cross-member(s) 216 may be permanent or removable. Where the attachment is removable, it should be appreciated that numerous mechanisms exist for attachment/removal without tools, but without sacrificing the secure attachment that one would typically wish to have in a vehicle-mounted cargo-carrying structure. The illustrated embodiment used stained cedar wood for the rails 202, 204 and tubular aluminum cross-members 216, but any other conventional materials may be used to provide a desired appearance, weight, and other characteristics, while remaining within the scope of the claimed embodiments.

The cross-member(s) 216 preferably will be mounted a predetermined distance above the upper surface of the solar array 300. The predetermined distance may be chosen based upon factors including but not limited to the kinds of cargo likely to be carried (e.g., with consideration of how such cargo might rest/ride and minimizing or at least lessening risk of the cargo contacting the solar array in a way that would damage it); allowing light to reach the solar array even when a cargo is disposed on the cross-member(s) 216; air-flow relative to the system 100 and cargo when mounted on a vehicle that is to be in motion; and/or other factors).

It should be appreciated from the description above and the drawing figures that the illustrated embodiment of system 100 is constructed, dimensioned, and positioned such that an upward-facing surface of solar array 300 is obscured from a view of an observer oriented along a longitudinal side at eye-level with the solar power system 100. This provides for aesthetic advantages including that a typical observer at or below the level of at least some embodiments of the system 100 will only see a fairly-typical cargo-carrying assembly instead of the combination solar-power and cargo-transport device actually disclosed here.

Through the past two decades, many different solar power appliances, including for use with vehicles have been developed and are both well known and commercially available. Accordingly, claims of the present disclosure are not directed to particular novel electrical structures and/or functions. Rather, as is diagrammatically depicted in FIG. 5, it should be appreciated that the solar panels 302 of the solar array 300 may be connected in electrical communication with one or more of a control system 381 configured for directing electrical power, an inverter 387, a battery 389 (including any power storage system, shown here as grounded in a “common to ground” configuration, although other configurations may be used), DC load(s) 383 (such as—by way of non-limiting example—vehicle accessory light(s), electrical system(s) of a vehicle, 12V bus, and/or other), AC load(s) 385 (such as—by way of non-limiting example—AC power outlets), and any combination thereof, using conventional means and commercially-available components. Specifically, integration of the solar-power portion of the present embodiments with a vehicle electrical system and/or with other systems for powering devices, charging batteries/devices, and other electrical functions may each be accomplished with reference to current, prior, or future-developed devices and systems that are commercially available or otherwise known. This includes that the solar array 300 may be connected in electrical communication with a power storage system (by way of non-limiting example: a power storage battery of a vehicle, such as one or more of a standard automotive battery for a combustion engine vehicle, a battery for a hybrid vehicle, and/or a battery for an electric vehicle), including as set forth above with reference to FIG. 5, which is not limiting and can be supplemented or modified within the state of the art (e.g., to provide charging for and/or as a supplement with a vehicle battery/power system, which can—in turn—be used to provide power to the other components already illustrated, such as when inadequate sunlight has been available). This system will work well for a variety of personal and/or professional uses including, for example, powering small appliances and lights during travel/camping, and/or recharging batteries for cordless/portable tools or other devices on a worksite, powering electric or hybrid vehicles, or any other use of electrical power.

Those of skill in the art will appreciate that embodiments not expressly illustrated herein may be practiced within the scope of the claims, including that features described herein for different embodiments may be combined with each other and/or with currently-known or future-developed technologies while remaining within the scope of the claims. Although specific terms are employed herein, they are used in a generic and descriptive sense only and not for purposes of limitation unless specifically defined by context, usage, or other explicit designation. It is therefore intended that the foregoing detailed description be regarded as illustrative rather than limiting. And, it should be understood that the following claims, including all equivalents, are intended to define the spirit and scope of this invention. Furthermore, the advantages described above are not necessarily the only advantages of the invention, and it is not necessarily expected that all of the described advantages will be achieved with every embodiment. In the event of any inconsistent disclosure or definition from the present application conflicting with any document incorporated by reference, the disclosure or definition herein shall be deemed to prevail.

I claim:

1. A solar power system for a vehicle, the system comprising:
a solar array including at least one solar panel, where the solar array is configured to generate at least 400 watts of electrical power;
a roof-mountable cargo-support structure including at least two generally parallel longitudinal rails attached to the solar array and constructed to support a cargo above the solar array and separated from the solar array by a predetermined distance; and
at least one cross-member permanently attached or removably attached to the at least two generally parallel longitudinal rails.

2. The solar power system of claim 1, where the solar array is configured to generate at least 400 watts of electrical power.

3. The solar power system of claim 1, where the solar array is attached to the roof-mountable cargo-support structure including both the solar array and the cargo-support structure being mutually attachable to a vehicle roof structure.

4. The solar power system of claim 3, constructed such that an upward-facing surface of the solar array is obscured from a view of an observer oriented along a longitudinal side at eye-level with the solar power system.

5. The solar power system of claim 1, wherein
the at least one cross member includes a plurality of cross members, and where removably attached includes removability without use of tools, and
where the longitudinal rails are directly attached to one or more of a roof of a vehicle, the roof of a vehicle-mounted accessory, and the cargo-support structure.

6. The solar power system of claim 5, comprising being attached to a vehicle-mountable accessory, where the vehicle-mountable accessory is a structure attachable to a truck-bed.

7. The solar power system of claim 6, where the vehicle-mounted accessory includes a camper shell.

8. The solar power system of claim 5, constructed such that an upward-facing surface of the solar array is obscured from a view of an observer oriented at eye-level with the solar power system.

9. The solar power system of claim 5, where all attachment locations to the roof of the vehicle are sealed to prevent water leakage.

10. The solar power system of claim 5, further comprising at least longitudinal support structure attached along an interior surface of the roof of a vehicle, the roof of the vehicle-mounted accessory, or both, forming an internal support attachment element to which the solar array, the cargo-support structure, or both the solar array and the cargo-support structure are anchored.

11. The solar power system of claim 1, further comprising being connected in electrical communication with one or more of a control system configured for directing electrical power, an inverter, a battery, a vehicle accessory light, an electrical system of a vehicle, power outlets, and any combination thereof.

12. The solar power system of claim 1, where each of one the at least two generally parallel rails is attached to at least one longitudinal support bar.

13. The solar power system of claim 12, where the cargo-support structure further includes at least cross-piece disposed generally transverse to, and attached to, the at least two generally parallel longitudinal rails and to the solar array.

14. The solar power system of claim 12,
where the cargo-support structure further includes at least two cross-pieces disposed generally transverse to, and attached to, the at least two generally parallel longitudinal rails and to the solar array, and
where a number of the at least one longitudinal support bars is the same as a number of at least two longitudinal rails.

15. The solar power system of claim 12, where at least one or more of a roof of a vehicle and the roof of a vehicle-mounted accessory is disposed between the at least one longitudinal support bar and at least one of the at least two generally parallel rails.

16. The solar power system of claim 1, further comprising being connected in electrical communication with a power storage system of a power storage battery of a vehicle, selected from a standard automotive battery for a combustion engine vehicle, a battery for a hybrid vehicle, or a battery for an electric vehicle.

17. A mounted installation including the solar power system of claim 1, comprising at least one of
being mounted to a truck-bed topper;
being mounted to a truck-bed-occupying accessory;
being mounted to a vehicle roof; and
any combination thereof.

18. A vehicle-mounted solar power system comprising a cargo-support rack configured to support cargo at a predetermined distance above at least one solar panel mounted to an exterior of a vehicle roof and attached to at least one support bar a support bar on an interior of a vehicle roof.

19. The vehicle-mounted solar power system of claim 18, wherein the at least one solar panel comprises a solar panel array providing at least 400 watts of electrical power.

20. The vehicle-mounted solar power system of claim 18, dimensioned and positioned such that an upward-facing surface of the at least one solar panel is obscured from a view of an observer oriented at eye-level with the solar power system.
